(19) United States
(12) Patent Application Publication
(10) Pub. No.: US 2017/0374028 A1
(43) Pub. Date: Dec. 28, 2017

(54) SOFTWARE-DEFINED NETWORKING CONTROLLER

(71) Applicant: NOKIA SOLUTIONS AND NETWORKS OY, Espoo (FI)

(72) Inventors: Ian Justin OLIVER, Söderkulla (FI); Silke HOLTMANNS, Klaukkala (FI)

(21) Appl. No.: 15/545,889

(22) PCT Filed: Jan. 28, 2015
(86) PCT No.: PCT/EP2015/051688

§ 371 Date: Jul. 24, 2017

(51) Int. Cl. H04L 29/06

(52) U.S. Cl. CPC H04L 63/0227; H04L 63/145; H04L 63/1416; H04L 63/1425

(57) ABSTRACT

A fault tolerant software-defined networking controller is provided by using in an alert mode a secondary soft-ware-defined networking controller.

### TECHNICAL FIELD

The invention relates to communications.

### BACKGROUND

In a networking paradigm called software-defined networking (SDN) lower-level functionality is abstracted by decoupling data forwarding (data plane) from overlying control decisions, such as routing and resource allocations. This is achieved by means of one or more software-based SDN controllers that allow the underlying network to be programmable via the SDN controllers independent of underlying network hardware. Typically in an SDN network an SDN controller is also physically separated from any of the controlled network switches, but is not necessarily located remotely therefrom.

### BRIEF DESCRIPTION

According to an aspect, there is provided the subject matter of the independent claims. Embodiments are defined in the dependent claims.

### BRIEF DESCRIPTION OF DRAWINGS

In the following, the invention will be described in greater detail by means of preferred embodiments with reference to the attached drawings, in which

FIG. 1 shows simplified architecture of a system and block diagrams of some apparatuses according to an exemplary embodiment;

FIG. 2 is a flow chart illustrating an exemplary functionality;

FIGS. 3 and 4 are illustrate exemplary information exchange and functionalities; and

FIG. 5 is a schematic block diagram of an exemplary apparatus.

### DETAILED DESCRIPTION OF SOME EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

The present invention is applicable to any network/system configured to sup-port software-defined networking and entities/nodes/apparatuses in such a network/system. Examples of such networks/systems include LTE (Long Term Evolution) access system based networks, Worldwide Interoperability for Microwave Access (WiMAX) based networks, Wireless Local Area Network (WLAN) based networks, LTE Advanced (LTE-A) based networks, and beyond LTE-A based networks, such as 4G (fourth generation) and 5G (fifth generation), cloud networks using Internet Protocol, mesh networks, and ad-hoc networks, such as LTE direct and mobile ad-hoc network (MANET).

The software-defined networking architecture has three layers: an infrastructure layer comprising different network devices, like switches, a control layer comprising software-based SDN controllers to which network intelligence is logically centralized, and an application layer for different applications. As a result, the network appears to the applications as a single, logical switch, accessible via one or more application programming interfaces. Network devices may be simplified, since thanks to instructions from an SDN controller, they need not to anymore understand and process a plurality of protocol standards, it suffices that a network device have a communication interface to an SDN controller, and is configured to use a communication protocol defined to be use over the interface. The communication protocol may be a propriety protocol, or an open standard protocol, for example. However, the specifications of different systems, networks and protocols develop rapidly. Such development may require extra changes to an embodiment. Therefore, all words and expressions should be interpreted broadly and they are intended to illustrate, not to restrict, the embodiment. For example, future networks will most probably utilize network functions virtualization (NFV) which is a network architecture concept that proposes virtualizing network node functions into “building blocks” or entities that may be operationally dynamically instantiated, connected or linked together to provide network services.

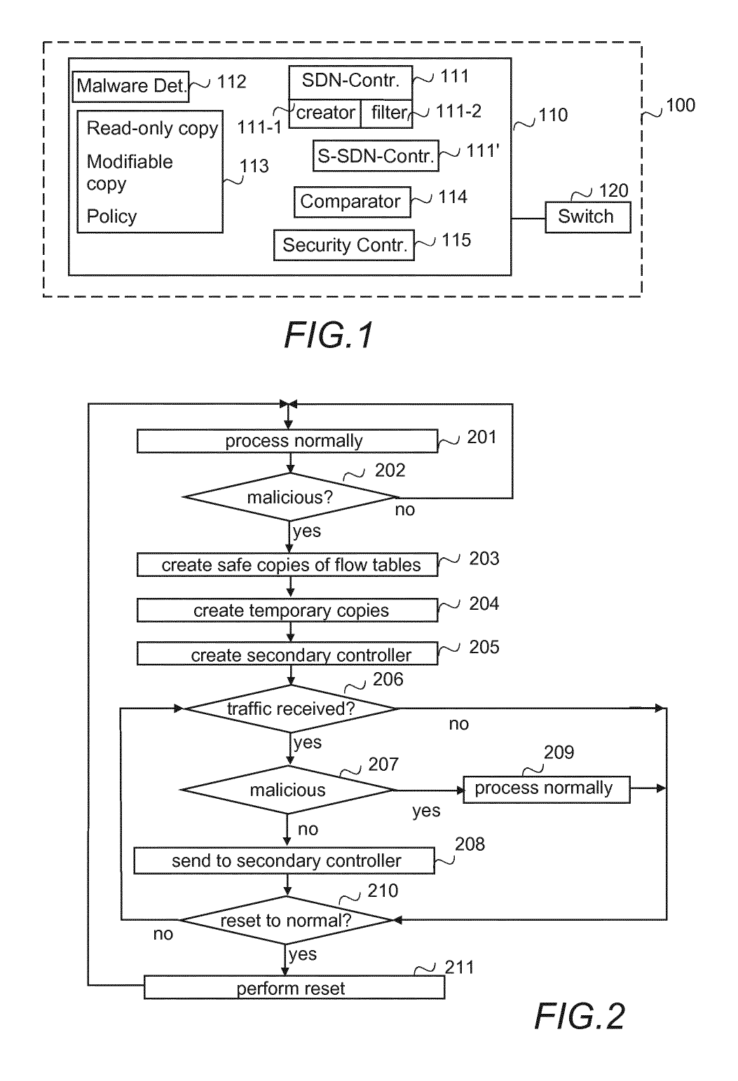

An extremely general architecture of an exemplary SDN system 100 is illustrated in FIG. 1. FIG. 1 is a simplified system architecture only showing some elements and functional entities, all being logical units whose implementation may differ from what is shown. It is apparent to a person skilled in the art that the system comprises other functions and structures that are not illustrated, for example applications in an application layer.

The exemplary system 100 comprises a control layer apparatus 110 and a traffic forwarding layer apparatus 120, such as a switch, a router, or a bridge, or other corresponding traffic forwarding entity. In an implementation, there is one physical connection (that may be divided into one or more different sub-connections/channels) in the traffic forwarding layer apparatus 120 for incoming network traffic including data and control information, and the traffic forwarding layer apparatus 120 forwards the control traffic to the SDN controller 111 in the control layer apparatus 110. In another implementation data and control plane traffic are not mixed but there is one physical connection in the control layer apparatus 110 for incoming network control information to the SDN controller and one physical connection for the incoming network data traffic in the traffic forwarding layer apparatus 120.

In the illustrated example, the control layer apparatus 110 comprises an SDN controller 111, a malware detection component 112, a memory 113 comprising one or more policies, a comparator unit 114 and a security control unit 115. Further, since the SDN controller is in the example in an alert mode (state), it comprises a secondary SDN controller 111′, and the memory 113 comprises at least two copies of a flow table: a read-only copy and one or more modifiable (read and write) copies. Below the read-only copy is called a safe copy of a flow table, and it is kind of a primary copy of the flow table, and the modifiable copy (updatable copy), which is a kind of a secondary copy, is called a temporary copy of the flow table. Typically, but not necessary, flow tables and corresponding copies are traffic forwarding layer apparatus-specific. Herein a copy means something that may be exactly the same as the original, or similar to the original, or slightly different than the original (i.e. a version of the original). In other words, it does not matter if some information in the original is not in the copy, it is still a copy. Further, predefined policies (i.e. one or more policy rules) may be common to all traffic forwarding layer apparatuses 120 controlled by the SDN controller 111, or one or more or all of the policies may be dedicated to one or some of the traffic forwarding layer apparatuses. It should be appreciated that although the apparatus is depicted as one entity, different components may locate in different physical entities, and they may be implemented as a software, hardware, firmware or any combination thereof.

The SDN controller is the core of an SDN network. As said above, it lies between network devices (traffic forwarding layer apparatus) at one end and applications at the other end, and any communications between applications and network devices have to go through the SDN controller. The SDN controller also uses one or more protocols, such as Open Flow, Border Gateway Protocol and/or similar routing and management protocols, to configure network devices and choose the optimal network path for application traffic. In other words, the SDN controller manages flow control and tells network devices (traffic forwarding layer apparatuses) where to send packets. In the illustrated example this information is provided by means of one or more flow tables (not illustrated in FIG. 1) maintained in the traffic forwarding layer apparatus 120. It should be appreciated that instead of a table structure, any other data structure providing routing information and/or resource allocation information may be used.

Since the SDN controller 111 is a critical component in the SDN network, a mechanism ensuring that the SDN controller 111 can continue to function even when attacked by malware traffic is provided by a mode unit 111-1 for creating safe copies of flow tables, temporary copies of flow tables and one or more secondary SDN controllers when a normal mode is changed to an alert mode, and for resetting the settings when the alert mode is changed to the normal mode, and a filter unit 111-2 for separating the malicious traffic and non-malicious traffic in the alert mode. The mechanism ensures that the SDN controller functions either in the normal mode or in the alert mode. Usually, but not necessarily, the secondary SDN controller is always created from scratch. Hence no resources are reserved unnecessarily to the secondary controller; the resources are received and used only when the secondary controller is needed. However, it is possibility to have a secondary SDN controller always ready to be waked up/started. Such a “hot standby” will reduce network latencies: no time to initialize the secondary SDN controller will be needed; it suffices just to send one or more flow tables. The “hot standby” feature may be useful in safety critical networks/systems, in networks/systems where low network latency is critical, and in networks/systems under high intrinsic load. Depending on an implementation, a secondary SDN controller may be of a general type (one secondary SDN controller for one SDN controller) or a traffic forwarding layer apparatus—specific secondary SDN controller (one secondary SDN controller for one traffic forwarding layer apparatus), or any combination thereof.

The secondary SDN controller 111′ is created to act as a honeypot, i.e. it processes all the traffic as if it were the SDN controller 111 running in a normal mode, and hence appears as the SDN controller to an originator of the malicious traffic. However, the secondary SDN controller 111′ is not allowed to write to the flow tables in the traffic forwarding layer apparatus 120. Thanks to that it is avoided that the attack impacts the rest of the network/system.

The malware detection component 112 is also part of the mechanism. The functionality how the malware detection component 112 detects malicious traffic bears no significance, and any known or future method may be used. The malware detection component 112 may also be a network device, i.e. not in the control layer, and hence not included in the control layer apparatus 110. Yet another alternative is that the malware detection component 112 is a separate device in the control layer. A traffic forwarding layer apparatus may be configured to direct incoming traffic to the malware detection component, or the incoming traffic may arrive to the traffic forwarding layer apparatus via the malware detection component, or the control plane traffic to the SDN controller may be transmitted via the malware detection component.

Although in the illustrated example, the control layer apparatus 110 comprises the comparator unit 114 (comparing unit) and in the memory 113 the one or more policies as part of the mechanism, the mechanism may be implemented without them as well. The functionality of the comparator unit 114 is described in more detail below with FIG. 4.

The security control unit 115 is also part of the mechanism. The security control unit 115 provides a management interface via which management commands, such as user input instructing to reset to normal mode, may be received. The security control unit may manage also other security related actions. Depending on an implementation, the security control unit 115 may be part of the SDN controller configured to run in a restricted operation system environment, i.e. in a sandbox, so that the security control unit functionality is separated from the functionality of the SDN controller, or the security control unit 115 may locate in a separate node/control layer apparatus. Regardless of the implementation, when the SDN controller is configured to return from the alert mode to the normal mode only if the instructions is received from/via the security control center, secure means against attacks are provided.

In the examples below it is assumed, for the sake of clarity, that the traffic forwarding layer apparatus is a switch and that only one switch with one flow table is involved without restricting the examples to such a solution. It is apparent for one skilled in the art how to implement the examples to situations in which several switches, or corresponding network devices/traffic forwarding layer apparatuses, are controlled by the SDN controller, and/or more than one flow table are involved and/or more than one secondary SDN controller are involved.

FIG. 2 is a flow chart illustrating functionality of the SDN controller in an exemplary implementation in which the comparator unit is not implemented.

Referring to FIG. 2, in the normal mode the SDN controller processes (step 201) control traffic the SDN controller receives normally until information that a malicious traffic is detected (step 202) is received from the malware detection component. In response to receiving the information the mode of the SDN controller changes from normal to alert. For example, a value indicating a probability of the traffic being malicious may be attached to the traffic, and if the value for the probability is over a preset limit, the SDN controller is configured to treat the traffic as malicious. Other examples includes use of one or more additional parameters explicitly indicating whether or not the traffic is malicious, or using the originating address, for example, for determining whether or not the traffic is malicious.

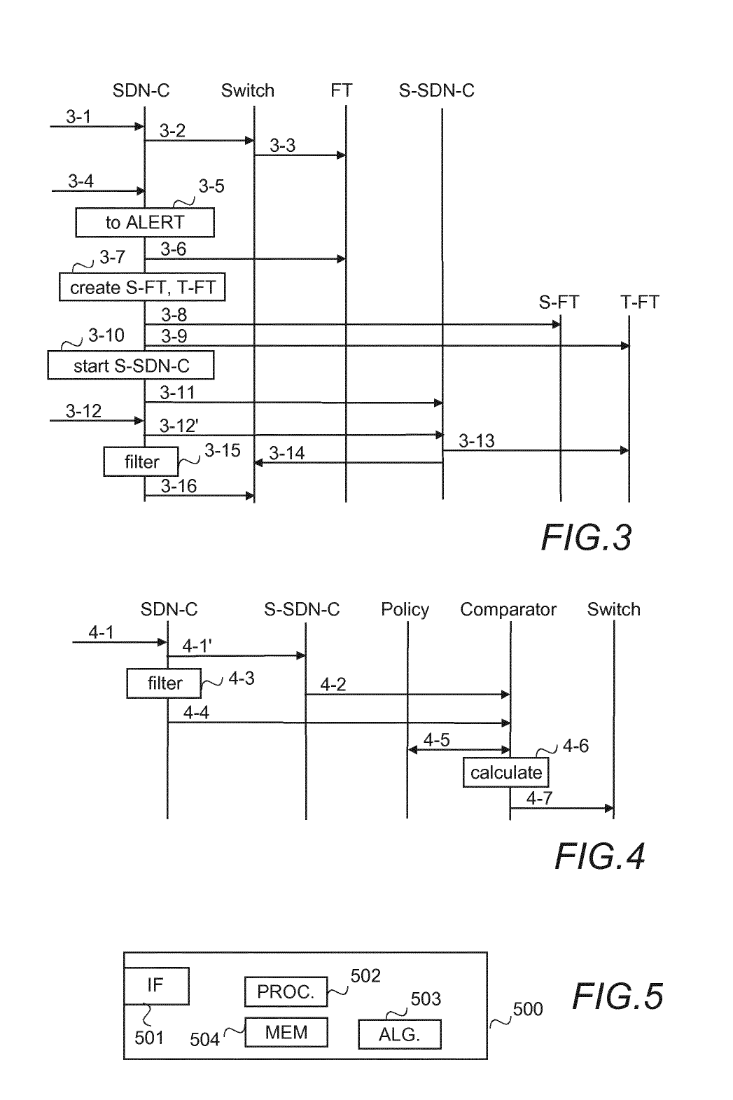

In the beginning of the alert mode, the SDN controller performs three creation operations. The SDN controller creates in step 203 safe copies of one or more flow tables in the switch by obtaining the corresponding information from the switch and storing the one or more safe copies to the memory. The safe copy of a flow table is a read-only copy of the current known state in the switch, just before the detected possible attack. The SDN controller creates in step 204 also temporary copies of one or more flow tables obtained from the switch and stores the one or more temporary copies to the memory. A temporary copy of a flow table is a writable copy whose use is illustrated below with FIGS. 3 and 4. In addition, the SDN controller creates in step 205 a secondary SDN controller to act as a honeypot. The functionality of the secondary SDN controller is similar to the functionality of the SDN controller in the normal mode with the exception that the secondary SDN controller is configured to update the one or more temporary flow tables, and hence is not able to update the flow tables in the switch. It should be appreciated that if the secondary controller exits already, it suffices to start it.

When control traffic is received (step 206) in the alert mode, it is checked, whether or not the control traffic is malicious (step 207). Malicious traffic is sent in step 208 to the secondary SDN controller, and non-malicious control traffic is processed normally in step 209. It should be appreciated that in another implementation also a copy of the non-malicious control traffic is sent to the secondary SDN controller; it suffices that malicious control traffic is filtered so that it will not be processed by the SDN controller.

After the control traffic has been handled (i.e. after step 208 or step 209), or if no control traffic is received, it is checked in step 210, whether or not an indication to reset to the normal mode is received. If not, the process returns to step 206 to monitor whether control traffic is received from the switch.

The indication to reset to the normal mode may be received from the security control unit or as a user input via the security control unit. Typically but not necessary the normal mode may be entered from the alert mode after malicious traffic ends, and/or the malicious control traffic have been analyzed, logged and the one or more temporary flow tables are processed. Naturally the analysis, logs and safe copies and temporary flow tables may be used for constructing rules for further malicious traffic differentiation and detection.

When the indication to reset to the normal mode is received, the reset is performed in step 211, after which the process proceeds to step 201 to process control traffic the SDN controller receives normally. In the reset the secondary SDN controller is shut down/destroyed, and the honeypot scheme is not any more used. The reset for the flow tables may be performed in a number of ways. For example, if the one or more temporary tables are noted to be sane (either by a person or by a specific software or any combination thereof), they are copied to be corresponding one or more flow tables in the switch. Another option is to copy the one or more safe copies back to the switch. Yet a further alternative is to allow the switch to continue the use of the one or more flow tables in the switch without replacing them. Still another alternative is to compute one or more sane flow tables from the one or more flow tables in the switch, the one or more safe copies and the one or more temporary flow tables.

In an implementation comprising the comparator unit, in the alert mode the non-malicious control traffic is processed (step 209) almost as normally, the exception being that instead of sending instructions to the switch the instructions are sent to the comparator unit.

FIG. 3 is a flow chart illustrating exemplary information exchange, part of which may be internal within an apparatus. The example illustrated in FIG. 3 relates to an implementation not comprising the comparator unit. Further, in the example it is assumed that all control traffic in the alert mode is forwarded to the secondary SDN controller and that the secondary SDN controller exists all the time so that it needs only to be started. However, it is obvious to one skilled in the art how to implement the example if only malicious control traffic is forwarded to the secondary SDN controller and/or the secondary SDN controller needs to be created. Referring to FIG. 3, the SDN controller SDN-C is in a normal mode and receives in message 3-1 non-malicious control traffic, processes it and sends instructions in message 3-2 to the switch to update its flow table FT. The switch updates the flow table FT by message 3-3. Message 3-2 may be for example “updateTable(x, R)” and message 3-3 “Add R”, “Delete R”, or “Modify R”.

Then SDN-C receives message 3-4 indicating malicious control traffic, and transfers in point 3-5 from the normal mode to the alert mode. SDN-C obtains/retrieves by message 3-6 a copy of the flow table in the switch. Then SDN-C creates in point 3-7 a safe copy of the flow table S-FT, using the obtained copy, and a temporary flow table TFT, using the obtained copy. Then the content of the flow table is transferred in messages 3-8 and 3-9 to be the content of the safe copy and the temporary flow table, correspondingly. Messages 3-8 and 3-9 may be “getCurrentTables”. In another example message 3-6 may be “getCurrentTables” and messages 3-8 and 3-9 may be “updateTables”. Further, the secondary SDN controller S-SDN-C is started by message 3-11. Message 3-11 may be “Start” or “Spawn”. In an example in which S-SDN-C is created, additional messages may be needed to create and start S-SDN-C.

Then SDN-C receives control traffic in message 3-12, and sends a copy of it to S-SDN-C in message 3-12′. S-SDN-C processes the control traffic as if it were SDN-C in a normal mode, and updates the temporary flow table to correspond the result by message 3-13. Further, since S-SDN-C functions as a honeypot, it sends message 3-14 to the switch so that the switch receives a normal return to the control traffic. Thanks to that, the sender of the malicious control traffic should not detect that the SDN controller processing control traffic has changed. The normal return to the control traffic, i.e. processing result(s) in message 3-14, may comprise routing information and/or resource allocation, for example.

In addition to sending a copy of message 3-12, SDN-C filters in point 3-15 malicious traffic from the received control traffic so that packets indicated as malicious are removed/filtered out, processes the non-malicious traffic as in normal mode and sends in message 3-16 normal return to the control traffic to the switch so that the switch may update its flow table, for example. The normal return to the control traffic, i.e. processing result(s) in message 3-16, may comprise routing information and/or resource allocation, for example.

FIG. 4 is a flow chart illustrating exemplary information exchange, part of which may be internal within an apparatus. The example illustrated in FIG. 4 relates to an implementation comprising the comparator unit utilizing one or more predefined policies defining the range of acceptable flow table configurations. Other examples of one or more predefined policies include thresholds for the probability of a control traffic being malicious, for example source—specifically, and requirements on sources of the flow tables. In the illustrated example it is assumed that the SDN controller SDN-C is already in the alert mode and that all control traffic is forwarded to a secondary SDN controller. It is obvious to one skilled in the art how to implement the example if only malicious control traffic is forwarded to the secondary SDN controller.

Referring to FIG. 4, SDN-C receives in message 4-1 control traffic, and sends a copy of it to a secondary SDN controller S-SDN-C in message 4-1′. S-SDN-C processes the control traffic as if it were SDN-C, and sends message 4-2 to the comparator, message 4-2 containing information on the result of the process, the result including an update to the temporary flow table. The processing result(s) in message 4-2 may comprise routing information and/or resource allocation, for example.

In addition to sending a copy of message 4-1, SDN-C filters in point 4-3 malicious traffic from the received control traffic, processes the non-malicious traffic as in normal mode and sends in message 4-4 information on the result of the process to the comparator, the result being a normal return to the control traffic including an update to the flow table maintained in the switch. The processing result(s) in message 4-4 may comprise routing information and/or resource allocation, for example.

The comparator obtains (messages 4-5) the one or more predefined policies that are needed in calculations. The comparator calculates in point 4-6 the differences between the updates, such as flow table deltas (differences), and update table commands, and other effects on the current temporary flow table state. An example of the other effects includes that a routing update has come from a known “spammer”, having an address within a known spamming range. Such a spammer may be a server on a black list. In the illustrated example it is assumed that the comparator finds out that the calculated differences fulfill requirements laid down in the policies and sends message 4-7 to the switch, so that the switch receives a normal return to the control traffic, and can update the flow table, for example. The normal return to the control traffic, i.e. comparison result(s) in message 4-7, may comprise routing information and/or resource allocation, for example

Examples of the one or more policies includes following two rules, without restricting the solution to such rules:

ALLOW if c1.updateTable( . . . )==c2.updateTable( . . . )

ALLOW if

apply(F,c1.updateTable( . . . ))⊚apply(F,c2.updateTable( . . . ))<εF

wherein

c1 denotes SDN-C;

c2 denotes S-SDN-C;

F denotes a flow table structure which may consist of one or more flowtables;

⊚ denotes a comparison between the calculated update tables; and

εF is a maximal difference between the two compared tables within which a valid flow table structure is obtainable, i.e. a metric over the difference of the flow table.

It should be appreciated that any rule and any comparison producing some kind of metric over the difference may be used, such as comparison of IP addresses. Further, any metric or bound may be used when determining the difference.

If the comparator finds out that the calculated differences do not fulfill requirements laid down in the policies, for example a difference is greater than the allowed maximal difference, the comparator may be configured to issue one or more warnings and/or errors and/or critical system failures, etc., or to do nothing. The configuration may be a preset configuration or defined in the one or more policies (policy rules), or any combination thereof.

It should be appreciated that in addition to the safe copy of the flow table and the temporary flow table, any number of copies of the flow table may be created, and any number of copies of the temporary flow table may be created at any stage as well.

As is evident from the above, a fault tolerant software-defined networking controller is provided by means of the alert mode functionality and the use of the secondary software-defined networking controller in a honeypot manner.

The steps/points, messages (i.e. information exchange) and related functions described above in FIGS. 2, 3 and 4 are in no absolute chronological order, and some of the steps/points and/or information exchange may be performed simultaneously or in an order differing from the given one. Other functions can also be executed between the steps/points or within the steps/points, and other messages sent. For example, in the alert mode the SDN controller may send notifications to the security control unit or via it to an entity managing the SDN controller. Some of the steps/points/messages or part of the steps/points/messages can also be left out or replaced by a corresponding step/point/message or part of the step/point/message.

The techniques described herein may be implemented by various means so that an apparatus/network node implementing one or more functions of a corresponding control layer apparatus/network node described with an embodiment/example/implementation comprises not only prior art means, but also means for implementing the one or more functions of a corresponding control layer apparatus described with an embodiment and it may comprise separate means for each separate function, or means may be configured to perform two or more functions. For example, the SDN controller and/or the mode unit and/or the filter unit and/or the secondary SDN controller and/or the comparator unit and/or algorithms may be software and/or software-hardware and/or hardware and/or firmware components (recorded indelibly on a medium such as read-only-memory or embodied in hard-wired computer circuitry) or combinations thereof. Software codes may be stored in any suitable, processor/computer-readable data storage medium(s) or memory unit(s) or article(s) of manufacture and executed by one or more processors/computers, hardware (one or more apparatuses), firmware (one or more apparatuses), software (one or more modules), or combinations thereof. For a firmware or software, implementation can be through modules (e.g., procedures, functions, and so on) that perform the functions described herein.

FIG. 5 is a simplified block diagram illustrating some units for an apparatus 500 configured to be a control layer apparatus comprising at least the SDN controller and/or the mode unit and/or the filter unit and/or the secondary SDN controller and/or the comparator unit, or corresponding functionality or some of the corresponding functionality if a hybrid or distributed scenario is implemented instead of a centralized implementation. In the illustrated example, the apparatus comprises an interface (IF) 501 for receiving and transmitting information, a processor 502 configured to implement at least the SDN controller and/or the mode unit and/or the filter unit and/or the secondary SDN controller and/or the comparator unit, described herein, or at least part of corresponding functionality as a sub-unit functionality, with corresponding algorithms 503, and memory 504 usable for storing a computer program code required for the SDN controller and/or the mode unit and/or the filter unit and/or the secondary SDN controller and/or the comparator unit, or a corresponding unit or sub-unit, i.e. the algorithms for implementing the functionality. The memory 704 is also usable for storing other possible information, like the safe copies and/or temporary flow tables.

In other words, an apparatus configured to provide the control layer apparatus, or an apparatus configured to provide one or more corresponding functionalities, is a computing device that may be any apparatus or device or equipment or node configured to perform one or more of corresponding apparatus functionalities described with an embodiment/example/implementation, and it may be configured to perform functionalities from different embodiments/examples/implementations. The SDN controller and/or the mode unit and/or the filter unit and/or the secondary SDN controller and/or the comparator unit, as well as corresponding units and sub-unit and other units, described above with a control layer apparatus may be separate units, even located in another physical apparatus, the distributed physical apparatuses forming one logical apparatus providing the functionality, or integrated to another unit in the same apparatus.

The apparatus configured to provide the control layer apparatus, or an apparatus configured to provide one or more corresponding functionalities may generally include a processor, controller, control unit, micro-controller, or the like connected to a memory and to various interfaces of the apparatus. Generally the processor is a central processing unit, but the processor may be an additional operation processor. Each or some or one of the units/sub-units and/or algorithms described herein may be configured as a computer or a processor, or a microprocessor, such as a single-chip computer element, or as a chipset, including at least a memory for providing storage area used for arithmetic operation and an operation processor for executing the arithmetic operation. Each or some or one of the units/sub-units and/or algorithms described above may comprise one or more computer processors, application-specific integrated circuits (ASIC), digital signal processors (DSP), digital signal processing devices (DSPD), programmable logic devices (PLD), field-programmable gate arrays (FPGA), and/or other hardware components that have been programmed and/or will be programmed by downloading computer program code (one or more algorithms) in such a way to carry out one or more functions of one or more embodiments/implementations/examples. An embodiment provides a computer program embodied on any client-readable distribution/data storage medium or memory unit(s) or article(s) of manufacture, comprising program instructions executable by one or more processors/computers, which instructions, when loaded into an apparatus, constitute the SDN controller and/or the mode unit and/or the filter unit and/or the secondary SDN controller and/or the comparator unit. Programs, also called program products, including software routines, program snippets constituting “program libraries”, applets and macros, can be stored in any medium and may be downloaded into an apparatus. In other words, each or some or one of the units/sub-units and/or the algorithms described above may be an element that comprises one or more arithmetic logic units, a number of special registers and control circuits.

Further, the apparatus configured to provide the control layer apparatus, or an apparatus configured to provide one or more corresponding functionalities may generally include volatile and/or non-volatile memory, for example EEPROM, ROM, PROM, RAM, DRAM, SRAM, double floating-gate field effect transistor, firmware, programmable logic, etc. and typically store content, data, or the like. The memory or memories may be of any type (different from each other), have any possible storage structure and, if required, being managed by any database management system. In other words, the memory may be any computer-usable non-transitory medium within the processor or external to the processor, in which case it can be communicatively coupled to the processor via various means. The memory may also store computer program code such as software applications (for example, for one or more of the units/sub-units/algorithms) or operating systems, information, data, content, or the like for the processor to perform steps associated with operation of the apparatus in accordance with examples/embodiments. The memory, or part of it, may be, for example, random access memory, a hard drive, or other fixed data memory or storage device implemented within the apparatus or external to the apparatus in which case it can be communicatively coupled to the apparatus via various means as is known in the art. An example of an external memory includes a removable memory detachably connected to the apparatus, a distributed database and a cloud server.

The apparatus configured to provide the control layer apparatus, or an apparatus configured to provide one or more corresponding functionalities may generally comprise different interface units, such as one or more receiving units and one or more sending/transmitting units. The receiving unit and the transmitting unit each provides an interface in an apparatus, the interface including a transmitter and/or a receiver or any other means for receiving and/or transmitting information, and performing necessary functions so that the information, etc. can be received and/or sent.

Further, the apparatus may comprise other units.

It will be obvious to a person skilled in the art that, as the technology advances, the inventive concept can be implemented in various ways. The invention and its embodiments are not limited to the examples described above but may vary within the scope of the claims.

1.-36. (canceled)

37. A method comprising:
detecting in a software-defined networking controller an initial malicious traffic;
triggering, in response to the detecting, one of starting and creating of at least one secondary software-defined networking controller;
creating, in response to the detecting, at least one read-only copy and at least one modifiable copy of each flow table in at least one traffic forwarding layer apparatus controlled by the software-defined networking controller;
filtering, by the software-defined networking controller, from received traffic malicious traffic;
processing by the software-defined networking controller the non-malicious traffic; and
performing one of forwarding from the software-defined networking controller to the at least one secondary software-defined networking controller at least the malicious traffic to be processed and forwarding from the software-defined networking controller to the secondary software-defined networking controller the non-malicious traffic and the malicious traffic to be processed.

38. The method of claim 37, further comprising:
performing the detecting in response to receiving from a malware detection component information indicating the initial malicious traffic.

39. The method of claim 37, further comprising:
shutting down, in response to detecting that it is safe to return to normal operation, the at least one secondary software-defined controller.

40. The method of claim 39, further comprising:
determining, in response to detecting that it is safe to return to normal operation, for each copied flow table a sane state of the flow table; and
updating each copied flow table to corresponding sane state.

41. The method of claim 37, further comprising:
sending, from the software-defined controller, processing results to at least one comparing unit.

42. The method of claim 41, further comprising:
processing by the secondary software-defined networking controller the traffic from the software-defined networking controller; and
sending from the secondary software-defined networking controller processing results to the at least one comparing unit.

43. The method of claim 42, further comprising:
comparing in the comparing unit the processing results from the software-defined networking controller with the processing results from the secondary software-defined networking controller; and
sending from the comparing unit the comparison result as a processing result to the at least one traffic forwarding layer apparatus.

44. The method of claim 43, further comprising:
obtaining by the comparing unit one or more policy rules; and
using the one or more policy rules in the comparing to determine the comparison result.

45. The method of claim 37, further comprising:
processing by the secondary software-defined networking controller the traffic from the software-defined networking controller; and
sending from the secondary software-defined networking controller processing results to the at least one traffic forwarding layer apparatus.

46. A control layer apparatus, comprising:
at least one processor, and
at least one memory for storing instructions to be executed by the processor, wherein
the at least one memory and the instructions are configured to, with the at least one processor, cause the apparatus at least to:
perform a software-defined networking controller functionality;
detect a received initial malicious traffic;
trigger, in response to the detecting, one of starting and creating of at least one secondary software-defined networking controller;
create, in response to the detecting, at least one read-only copy and at least one modifiable copy of each flow table in at least one traffic forwarding layer apparatus controlled by the control layer apparatus as the software-defined networking controller;
filter from received traffic malicious traffic;
process the filtered non-malicious traffic; and
perform one of forwarding to the secondary software-defined networking controller at least the malicious traffic to be processed, and forwarding from the software-defined networking controller to the secondary software-defined networking controller the non-malicious traffic and the malicious traffic to be processed.

47. The control layer apparatus of claim 46, wherein
the at least one memory and the instructions are configured to, with the at least one processor, further cause the apparatus at least to perform:
shutting down, in response to detecting that it is safe to return to normal operation, the at least one secondary software-defined controller.

48. The control layer apparatus of claim 47, wherein
the at least one memory and the instructions are configured to, with the at least one processor, further cause the apparatus at least to perform:
determining, in response to detecting that it is safe to return to normal operation, for each copied flow table a sane state of the flow table; and
updating each copied flow table to corresponding sane state.

49. The control layer apparatus of claim 47, wherein
the at least one memory and the instructions are configured to, with the at least one processor, further cause the apparatus at least to perform:
sending, from the software-defined controller, processing results to at least one comparing unit.

50. The control layer apparatus of claim 47, wherein
the at least one memory and the instructions are configured to, with the at least one processor, further cause the apparatus at least to perform:
detecting that it is safe to return to normal operation only in response to receiving a corresponding indication from a security control unit.

51. A non-transitory computer readable media having stored thereon instructions that, when executed by an apparatus, cause the apparatus to:
operate as a software-defined networking controller;
trigger, in response to detecting an initial malicious traffic, one of starting or creating of at least one secondary software-defined networking controller;
create, in response to the initial malicious traffic, at least one read-only copy and at least one modifiable copy of each flow table in at least one traffic forwarding layer apparatus controlled by the software-defined networking controller;
filter from received traffic malicious traffic;
process the filtered non-malicious traffic; and
perform one of forwarding to the secondary software-defined networking controller at least the malicious traffic to be processed, and forwarding from the software-defined networking controller to the secondary software-defined networking controller the non-malicious traffic and the malicious traffic to be processed.

52. A system comprising:
at least one traffic forwarding layer apparatus using at least one flow table;
at least one software-defined networking controller controlling at least one of the at least one traffic forwarding layer apparatus and being configured to
detect reception of an initial malicious traffic;
trigger, in response to detecting, one of starting and creating of at least one secondary software-defined networking controller;
create, in response to the detecting, at least one read-only copy and at least one modifiable copy of each flow table in at least one traffic forwarding layer apparatus controlled by the software-defined networking controller;
filter from received traffic malicious traffic;
process the non-malicious traffic; and
perform one of forwarding to the at least one secondary software-defined networking controller malicious traffic to be processed and forwarding to the secondary software-defined networking controller both the non-malicious traffic and the malicious traffic to be processed;
a network entity to which at least one secondary software-defined networking controller of at least one of the at least one software-defined networking controller may be created to be started in response to receiving corresponding instructions from the at least one of the at least one software-defined networking controller, to process control traffic received from the at least one of the at least software-defined networking controller, the control traffic received comprising either malicious traffic or both malicious and non-malicious traffic, as if the secondary software-defined networking controller would be the at least one of the at least one software-defined networking controller and to treat all control traffic as non-malicious; and to send from the secondary software-defined networking controller processing results including routing instructions to one of the at least one traffic forwarding layer apparatus and a comparing unit to be forwarded to the at least one traffic forwarding layer apparatus;
wherein at least one of the at least one modifiable copy of the at least one flow table is used by the at least one secondary software-defined networking controller after it has been started.

53. The system of claim 52, wherein:
the at least one software-defined networking controller controlling is further configured to send processing results to the at least one comparing unit; and
the at least one comparing unit is configured to
receive from the at least one of the at least one software-defined networking controller a first processing results relating to a non-malicious control traffic;
receive from the at least one secondary software-defined networking controller a second processing results relating to one of malicious control traffic and both malicious and non-malicious control traffic;
obtain one or more policy rules;
compare, using the one or more policy rules, the first processing results with the second processing results to determine a comparison result; and
send the comparison result as a processing result from the at least one of the at least one software-defined networking controller to at least one of the at least one traffic forwarding layer apparatus.
